(19) United States
(12) Patent Application Publication
(10) Pub. No.: US 2024/0274019 A1
(43) Pub. Date: Aug. 15, 2024

(54) SYSTEMS AND METHODS FOR COLLISION THREAT AWARENESS FOR A MOBILE PLATFORM HAVING A SEARCHLIGHT

(71) Applicant: HONEYWELL INTERNATIONAL INC., Charlotte, NC (US)

(72) Inventors: Mohammed Ibrahim Mohideen, Bangalore (IN); Anil Kumar Songa, Bangalore (IN); Saravanakumar Gurusamy, Bangalore (IN); Bincicil Mathew, Bangalore (IN); Anita Sure, Bangalore (IN); Harish Nagarajaiah, Bangalore (IN); Roshini Mehboob, Bangalore (IN)

(73) Assignee: HONEYWELL INTERNATIONAL INC., Charlotte, NC (US)

(21) Appl. No.: 18/193,213

(22) Filed: Mar. 30, 2023

(30) Foreign Application Priority Data
Feb. 10, 2023 (IN) 202311008704

(51) Int. Cl. G08G 5/04; B64D 43/00; B64D 47/04; F21S 8/00; F21V 21/15; G08G 5/00

(52) U.S. Cl. CPC G08G 5/045; B64D 43/00; B64D 47/04; F21S 8/003; F21V 21/15; G08G 5/0047; G08G 5/0073; B64C 27/04

(57) ABSTRACT

Methods and systems are provided for promoting collision threat awareness for a mobile platform. The system comprises a searchlight to emit a beam of light and means for articulating the searchlight, a sensor system to sense a location, elevation, and orientation of the mobile platform and/or locations and elevations of obstacles including terrain and manmade objects, a source of data including the locations and elevations of the obstacles, and a controller configured to, by a processor: identify a first obstacle that poses a collision threat to the mobile platform based on the location, elevation, and/or orientation of the mobile platform and the location and elevation of the first obstacle, and operate the searchlight assembly to: automatically direct the beam of light toward the first obstacle, and/or automatically direct the beam of light toward an escape route that allows the mobile platform to avoid collision with the first obstacle.

### CROSS-REFERENCE TO RELATED APPLICATION

This application claims priority to India Provisional Patent Application No. 202311008704, filed Feb. 10, 2023, the entire content of which is incorporated by reference herein.

### TECHNICAL FIELD

The present invention generally relates to collision threat awareness for mobile platforms, and more particularly relates to a system that automatically identifies collision threats proximate to a mobile platform and directs an onboard searchlight either toward the collision threats or toward an escape route that avoids the collision threats.

### BACKGROUND

Controlled Flight into Terrain/Obstacle/Water (CFIT) accidents continue to occur during helicopter operations. CFIT is a type of accident in which a functioning aircraft is unintentionally flown into the ground, man-made objects, water, or the like. CFIT is a heavy contributor to accidents with helicopter emergency medical services (HEMS) rotorcraft as pilots may be prone to fly in inclement weather and nighttime conditions and may be relatively inexperienced. In addition, single-engine pilots may be prone to fly visual flight rules (VFR) at lower altitudes and under clouds and weather thereby increasing the likelihood of CFIT accidents.

Hence, there is a need for systems and methods that promote collision threat awareness for rotorcraft and thereby reduce the occurrence of CFIT accidents. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for promoting collision threat awareness for a mobile platform. The system comprises a searchlight assembly comprising a searchlight mounted on the mobile platform, the searchlight configured to emit a beam of light and the searchlight assembly configured to controllably articulate the searchlight to modify a direction of the beam of light, a sensor system configured to sense a location, an elevation, and an orientation of the mobile platform and/or locations and elevations of various obstacles including terrain and manmade objects, a source of data including the locations and the elevations of the various obstacles, and a controller operably coupled to the searchlight assembly, the sensor system, and the source of data, the controller configured to, by a processor: identify a first obstacle within a flight path of and/or an area adjacent to the mobile platform that poses a collision threat to the mobile platform based on the location, the elevation, and/or the orientation of the mobile platform as sensed by the sensor system and the location and the elevation of the first obstacle as stored in the data and/or sensed by the sensor system, and operate the searchlight assembly to: automatically direct the beam of light toward the first obstacle, and/or automatically direct the beam of light toward an escape route determined based on the various obstacles in the data, wherein the escape route represents a safe flight path that allows the mobile platform to avoid collision with the first obstacle.

A method is provided for promoting collision threat awareness for a mobile platform. The method comprises receiving, with a processor of a controller of the mobile platform, a location, an elevation, and an orientation of the mobile platform from a sensor system of the mobile platform, receiving, by the processor, data including locations and elevations of various obstacles including terrain and manmade objects from a source of the data, identifying, by the processor, a first obstacle within a flight path of and/or an area adjacent to the mobile platform that poses a collision threat to the mobile platform based on the location, the elevation, and/or the orientation of the mobile platform as sensed by the sensor system and the location and the elevation of the first obstacle as stored in the data and/or sensed by the sensor system, operating a searchlight assembly to emit a beam of light from a searchlight mounted on the mobile platform, controllably articulating the searchlight, by the processor, to modify a direction of the beam of light to: automatically direct the beam of light toward the first obstacle, and/or automatically direct the beam of light toward an escape route determined based on the various obstacles in the data, wherein the escape route represents a safe flight path that allows the mobile platform to avoid collision with the first obstacle

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 present an exemplary helicopter having a collision threat awareness system in accordance with an embodiment;

FIG. 2 schematically represents components of the collision threat awareness system of FIG. 1 in accordance with an embodiment;

FIG. 3 is a dataflow diagram illustrating operation of the collision threat awareness system of FIGS. 1 and 2 in accordance with an embodiment;

FIG. 4 is a flowchart illustrating an exemplary method for providing collision threat awareness in accordance with an embodiment;

FIGS. 5 and 6 are avionics displays including visual icons highlighting a collision threat, within and out of a field of view of the display, respectively, in accordance with certain embodiments; and

FIG. 7 is an avionic display including a visual icon indicating an escape route in accordance with certain embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for automatically identifying collision threats during operation of a mobile platform and directing an onboard searchlight to illuminate either the collision threats or an escape route that includes a path intended to avoid the collision threats. The mobile platform may be any type of vehicle, such as but not limited to various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned helicopter; however, as noted the systems and methods are not limited to such application.

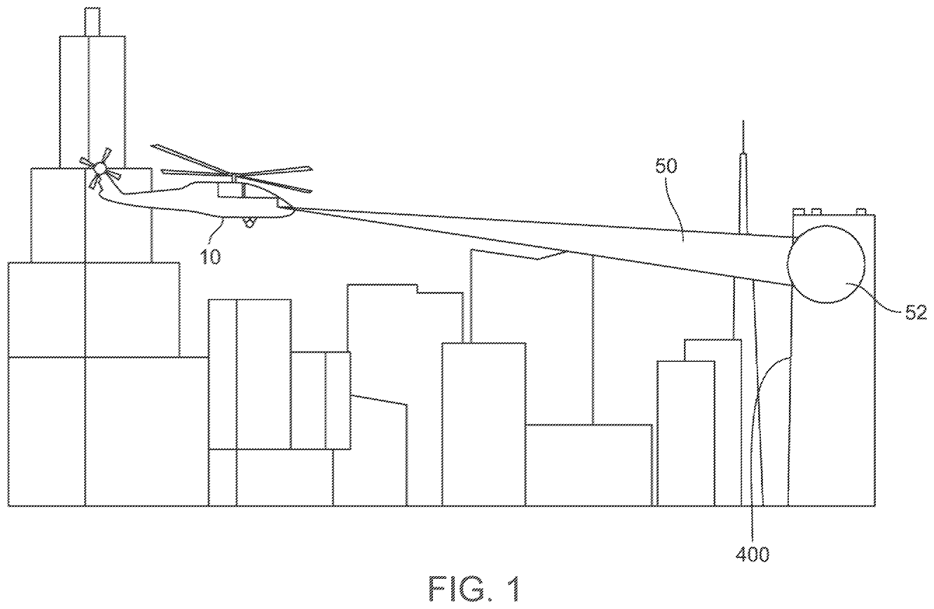

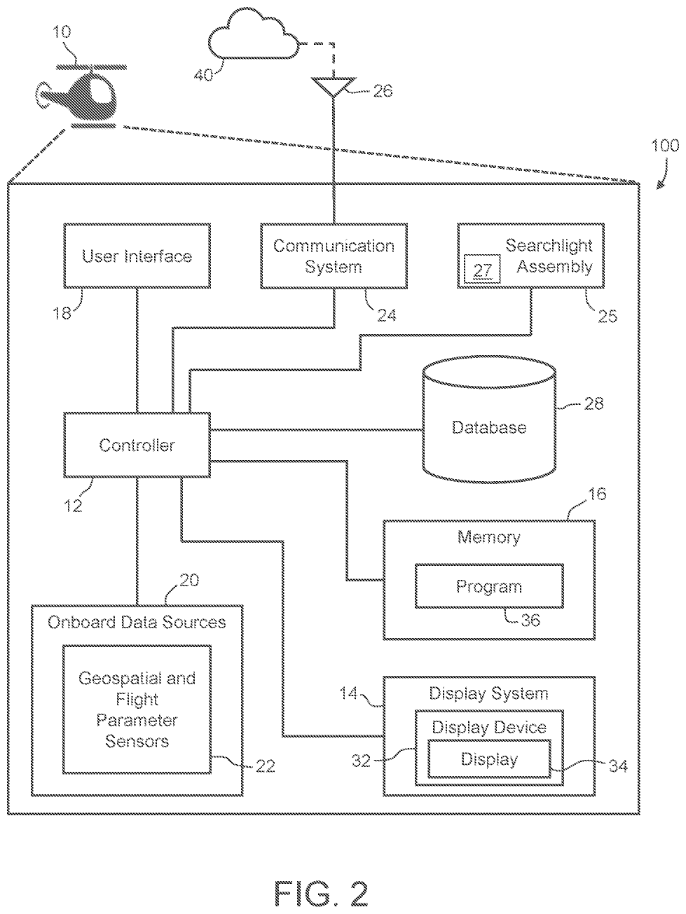

Referring now to FIGS. 1 and 2, an aircraft, in this example a helicopter 10, and certain systems thereof are illustrated in accordance with an exemplary and non-limiting embodiment of the present disclosure. A collision threat awareness system 100 may be utilized onboard the helicopter 10 as described herein. As schematically depicted in FIG. 2. the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger on-board display system 14; computer-readable storage media or memory 16; an optional user interface 18, and ownship data sources 20 including, for example, an array of flight system status and geospatial sensors 22. The system 100 may be separate from or integrated within a flight management system (FMS) and/or a flight control system (FCS). The system 100 may also contain a communication system 24 including an antenna 26, which may wirelessly transmit data to and receive data from various sources external to the system 100.

Although schematically illustrated in FIG. 2 as a single unit, the individual elements and components of the system 100 can be implemented in a distributed manner utilizing any practical number of physically distinct and operatively interconnected pieces of hardware or equipment. When the system 100 is utilized as described herein, the various components of the system 100 will typically all be located onboard the helicopter 10.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the helicopter 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 2, embodiments of the helicopter 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

In various embodiments, the communication system 24 is configured to support instantaneous (i.e., real time or current) communications between on-board systems, the controller 12, and one or more external data source(s) 40. The communication system 24 may incorporate one or more transmitters, receivers, and the supporting communications hardware and software required for components of the system 100 to communicate as described herein. In various embodiments, the communication system 24 may have additional communications not directly relied upon herein, such as bidirectional pilot-to-ATC (air traffic control) communications via a datalink, and any other suitable radio communication system that supports communications between the helicopter 10 and various external source(s).

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for determining and identifying collision threats may be part of the system 100. In certain embodiments, the source is one or more databases 28 employed to receive and store map data, which may be updated on a periodic or iterative basis to ensure data timeliness. In various embodiments, the map data may include various terrain and manmade object locations and elevations and may be stored in the memory 16 or in the one or more databases 28, and referenced by the program 36. In various embodiments, these databases 28 may be available online and accessible remotely by a suitable wireless communication system, such as the communication system 24.

The sensor system 22 supplies various types of data and/or measurements to the controller 12. In various embodiments, the sensor system 22 supplies, without limitation, one or more of: inertial reference system measurements providing a location, Flight Path Angle (FPA) measurements, airspeed data, groundspeed data, vertical speed data, vertical acceleration data, altitude data, attitude data including pitch data and roll measurements, yaw data, data related to ownship weight, time/date information, heading information, data related to atmospheric conditions, flight path data, flight track data, radar altitude data, geometric altitude data, wind speed and direction data. Further, in certain embodiments of the system 100, the controller 12, and the other components of the system 100 may be included within or cooperate with any number and type of systems commonly deployed onboard aircraft including, for example, an FMS, an Attitude Heading Reference System (AHRS), an Instrument Landing System (ILS), and/or an Inertial Reference System (IRS).

With continued reference to FIG. 2, the display device 32 can include any number and type of image generating devices on which one or more avionic displays 34 may be produced. In various embodiments, the display device 32 may be affixed to the static structure of the helicopter 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the helicopter 10 cockpit by a pilot.

At least one avionic display 34 is generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 is configured to continuously render at least one avionic display 34 showing a terrain environment at a current location of the helicopter 10. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

In various embodiments, a human-machine interface, such a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

The searchlight assembly 25 may include various components including a searchlight 27 configured to emit a beam of light 50 that illuminates a light spot 52 on an object on which the beam of light 50 impinges, an actuation system comprising one or more actuators configured to control the position of the searchlight 27 and thereby the direction of the beam of light 50, and a searchlight controller configured to control the actuation system based on preprogrammed instructions and/or pilot input.

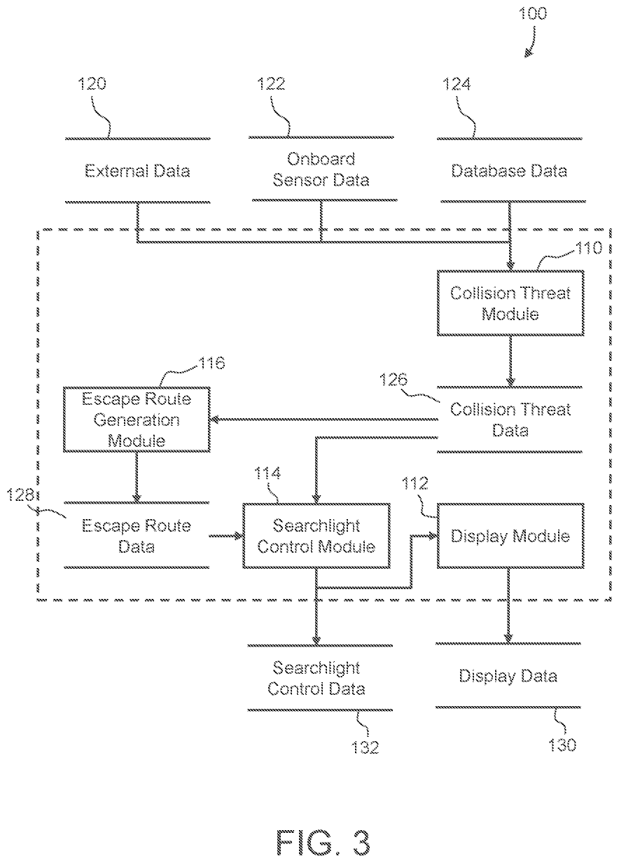

With reference to FIG. 3 and with continued reference to FIGS. 1-2, a dataflow diagram illustrates elements of the system 100 of FIG. 2 in accordance with various embodiments. As can be appreciated, various embodiments of the system 100 according to the present disclosure may include any number of modules embedded within the controller 12 which may be combined and/or further partitioned to similarly implement systems and methods described herein. Furthermore, inputs to the system 100 may be received from other control modules (not shown) associated with the helicopter 10, and/or determined/modeled by other sub-modules (not shown) within the controller 12. Furthermore, the inputs might also be subjected to preprocessing, such as sub-sampling, noise-reduction, normalization, feature-extraction, missing data reduction, and the like. In various embodiments, the system 100 includes a collision threat module 110, a display module 112, a searchlight control module 114, and an escape route generation module 116.

In various embodiments, the collision threat module 110 receives as input external data 120 received from the external sources 40 via the communication system 24, onboard sensor data 122 generated by the sensors 22, and/or onboard database data 124 retrieved from the database 28. The external data 120 includes various data indicating information relating to locations and elevations of terrain (e.g., trees, mountains, hills, bodies of water, etc.), manmade objects (buildings, bridges, utility lines, etc.), and the like. The onboard sensor data 122 includes various data indicating sensed locations and/or elevations of terrain, manmade objects, and the like, sensed operating parameters of the helicopter 10, and/or environmental conditions (e.g., wind speed and/or direction; e.g., Automatic Terminal Information Service (ATIS) data or Air Data Computer (ADC) data) in a geographic area relevant to the helicopter 10 (e.g., adjacent to, along a flight path thereof, proximate to, etc.). The onboard database data 124 may include various data indicating information relating to locations and elevations of terrain, manmade objects, and the like.

The collision threat module 110 may analyze the external data 120, the sensor data 122, and/or the database data 124 to identify collision threats, that is, terrain, man-made objects, or the like (collectively referred to as obstacles) that are within in a geographic area relevant to the helicopter 10 that pose a threat of collision to the helicopter 10 based on, for example, a sensed position, elevation, orientation, direction of travel of the helicopter 10, a distance between the obstacle and the helicopter 10, etc. For example, the collision threat module 110 may determine that the helicopter 10 is likely to or has a potential to collide with a nearby obstacle (e.g., a building) based on the operating parameters of the helicopter 10 and the position and elevation of the obstacle as stored in the received data (i.e., the external data 120, the sensor data 122, or the database data 124). The determination of whether an obstacle is a collision threat, that is, poses a threat of collision with the helicopter 10, may be based on various preprogrammed criteria, such as a threshold relating to a minimum distance between the helicopter 10 and the obstacle. The collision threat module 110 generates collision threat data 126 that includes various data identifying collision threats.

In various embodiments in which the collision threat is intended to be illuminated, the searchlight control module 114 receives as input the collision threat data 126 generated by the collision threat module 110. The searchlight control module 114 may generate searchlight control data 132 configured to cause the searchlight assembly 25 to direct a beam of light 50 toward the collision threat 400 (e.g., a building in FIG. 1) to illuminate at least a portion of the collision threat 400. In some embodiments, the beam of light 50 may be directed to produce a light spot 52 illuminating a portion of the collision threat 400 at a position which was determined by the collision threat module 110 to be a potential or likely point of impact in the event of a collision between the helicopter 10 and the collision threat 400.

In various embodiments, the escape route generation module 116 receives as input the collision threat data 126 generated by the collision threat module 110. The escape route generation module 116 analyzes the collision threat data 126 to determine an escape route based on the obstacle(s) identified as collision threats. The escape route represents a safe flight path that allows the helicopter 10 to avoid collision with the obstacle(s). The escape route generation module 116 generates escape route data 128 that includes various data indicating the determined escape route.

In embodiments in which an escape route is to be illuminated, the searchlight control module 114 receives as input the escape route data 128 generated by the escape route generation module 116. The searchlight control module 114 may generate the searchlight control data 132 configured to cause the searchlight assembly 25 to direct the beam of light 50 toward or along the determined escape route (e.g., between obstacles identified as collision threats).

In various embodiments, the display module 112 receives as input the searchlight control data 132 generated by the searchlight control module 114. The display module 112 generates display data 130 that includes various data configured to cause one or more graphic icons to be rendered on the display device 32 that visually indicates a location of the light spot 52, the collision threat 400, and/or the escape route.

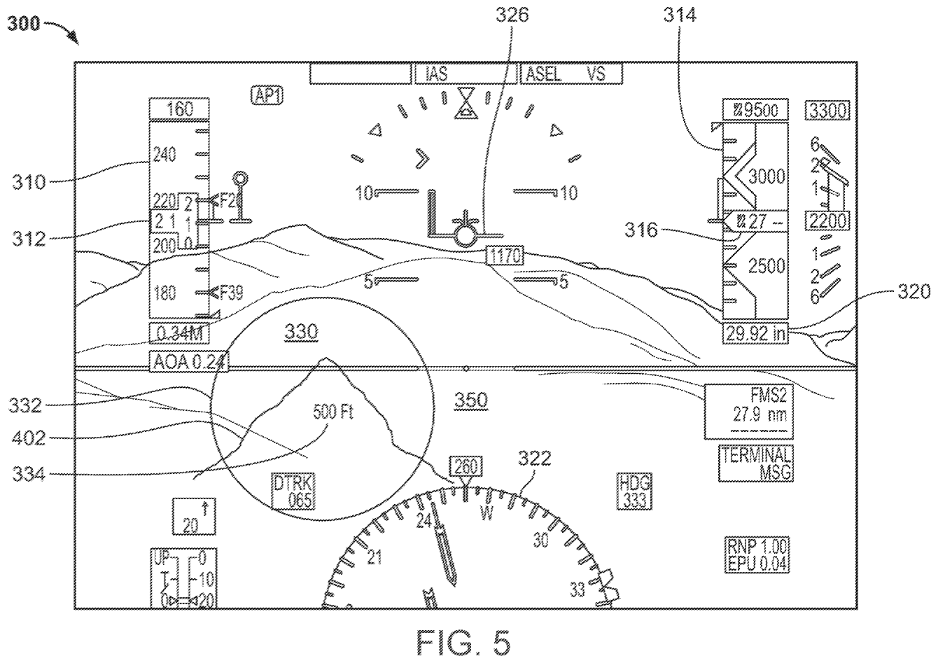

In various embodiments in which the collision threat is intended to be illuminated, the display data 130 may include various data configured to cause one or more graphic icons to be rendered on the display device 32 that indicates, identifies, and/or highlights the collision threat 400. For example, FIG. 5 represents an example of the display 34, referred to herein as a primary flight display (PFD) 300, generated on the display device 32. The PFD 300 includes various graphical elements including, but not limited to, a compass 322; an airspeed indicator or “airspeed tape” 310, which features a precision readout window 312; an altitude indicator or “altitude tape” 314, which features a precision readout window 316; a barometric pressure setting readout 320 (located beneath the altitude tape 314); and a flight path vector graphic or flight path marker (FPM) 326, which moves across the PFD 300 to reflect changes in the flight path of the helicopter 10.

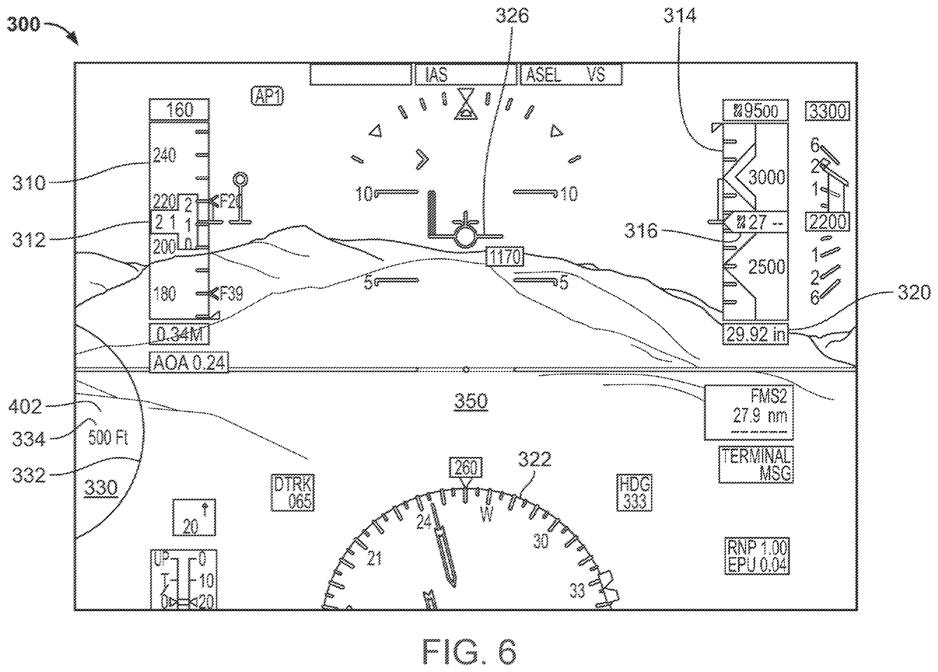

The PFD 300 is a perspective view Synthetic Vision System (SVS) display including graphical renderings of terrain and other geographical features representing the view from the cockpit under ideal visibility conditions (a so-called “glass cockpit” view). The simulated “glass cockpit” view produced on the PFD 300 thus includes an environmental graphic 350, which represents a first-person view of a real terrain environment which the helicopter 10 is presently approaching (typically oriented in or limited to a forward field of view relative to the helicopter 10). Additionally, the PFD 300 includes a dynamic visual element 332 representative of a location of the collision threat 400 that poses a threat to the helicopter 10. The visual element 332, also referred to herein as the collision threat icon 332, may be rendered on the PFD 300 in response to identification of a collision threat 402 (e.g., elevated terrain in FIGS. 5 and 6). In the exemplary embodiment shown in FIG. 5, the collision threat icon 332 includes a circle having an interior region 330 highlighting a portion of the collision threat 402. However, the collision threat icon 332 is not limited to a circular shape.

In some embodiments, the collision threat icon 332 may be configured to highlight the light spot 52 of the beam of light 50, configured to highlight the potential or likely point of impact in the event of a collision between the helicopter 10 and the collision threat 402, or may be configured to provide visual prominence.

In various embodiments, the display data 130 may include data configured to cause relevant data to be rendered on the display device 32. For example, FIG. 5 includes a distance measurement 334 (e.g., 500 ft) between the collision threat 402 and the helicopter 10 that is rendered within the interior region 330 of the collision threat icon 332.

In various embodiments, the collision threat 402 may be located out of view relative to the display 34 and the collision threat icon 332 may be rendered on the display device 32 in a manner that indicates that the collision threat 402 is out of view. For example, FIG. 6 presents the collision threat icon 332 as a semicircle or partial circle located adjacent a side of the display 34. In this example, the location and shape of the collision threat icon 332 is intended to indicate that the collision threat 402 is to the corresponding side of the helicopter 10 (i.e., the left-hand/port side).

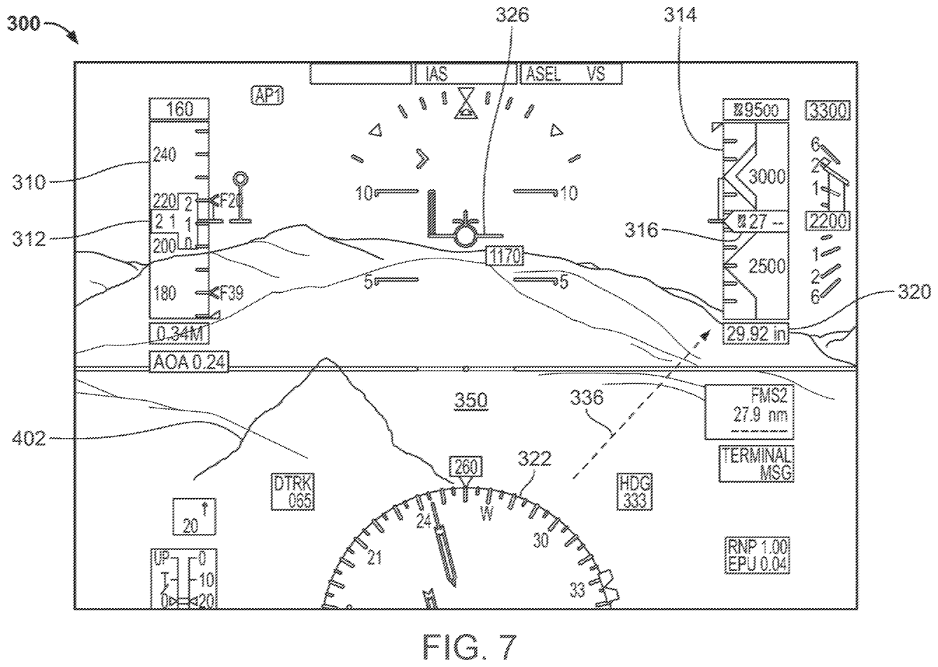

In embodiments in which an escape route is to be illuminated, the display data 130 may include various data configured to cause an escape route icon to be rendered on the display device 32 that indicates, identifies, and/or highlights the escape route. For example, the escape route icon may represent a position of the light spot 52, a direction of the beam of light 50, or a path along the escape route. In FIG. 7, an escape route icon 336 is rendered on the PFD 300 that indicates an escape route that the helicopter 10 may travel to avoid obstacles, including the collision threat 402.

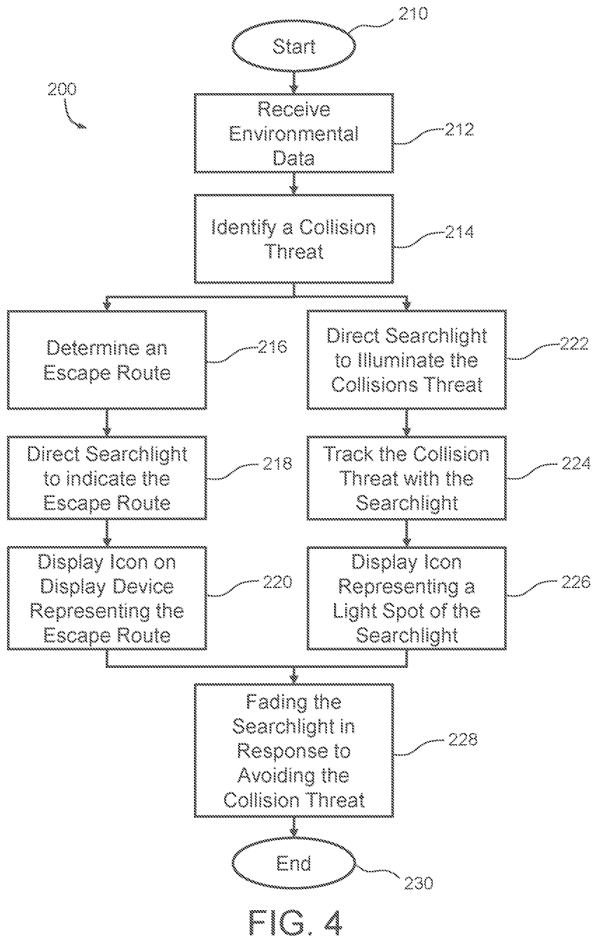

With reference now to FIG. 4 and with continued reference to FIGS. 1-3, a flowchart provides a method 200 for providing collision threat awareness as performed by the system 100, in accordance with exemplary embodiments. As can be appreciated in light of the disclosure, the order of operation within the method 200 is not limited to the sequential execution as illustrated in FIG. 4, but may be performed in one or more varying orders as applicable and in accordance with the present disclosure. In various embodiments, the method 200 can be scheduled to run based on one or more predetermined events (e.g., during poor visibility conditions), and/or can run continuously during operation of the helicopter 10.

The method 200 may begin at 210. At 212, the method 200 may include receiving environmental data that includes information relating to an environment adjacent to the helicopter 10 and/or along a flight path thereof. For example, the environmental data may include the external data 120, the sensor data 122, and/or the database data 124. At 214, the method 200 may include identifying a collision threat (e.g., collision threat 400 or 402) based on the environmental data. At 216, the method 200 may include determining an escape route that includes a path configured to avoid obstacles in the environmental data. At 218, the method 200 may include directing the searchlight 27 of the helicopter 10 to indicate the escape route or a portion thereof. At 220, the method 200 may include displaying an escape route icon (e.g., escape route icon 336) on the display device 32 of the helicopter 10 representing the escape route or a portion thereof.

Alternatively or in addition to the above, at 222, the method 200 may include directing the searchlight 27 to illuminate the collision threat. At 224, the method 200 may include tracking the collision threat with the searchlight 27, that is, position locking the searchlight 27 such that the beam of light (e.g., beam of light 50) is continuously directed toward the collision threat while the helicopter 10 is moving. At 226, the method 200 may include displaying a collision threat icon (e.g., collision threat icon 332) on the display device 32 representing a light spot (e.g., light spot 52) produced by the searchlight 27.

At 228, the method 200 may include fading the searchlight 27 in response to the helicopter 10 avoiding the collision threat, that is, the obstacle that was previously identified as the collision threat is no longer considered to be a threat to the helicopter 10. The method 200 may end at 230.

In various embodiments, the system 100 may be configured to optionally use the searchlight 27 and the display device 32 to indicate the escape route or the collision threat. In such embodiments, the system 100 may automatically switch between these functions based on preprogramed criteria, and/or a pilot may be provided with the ability to manually switch between the features. In such embodiments, the system 100 may indicate to the pilot which of the features is currently active. For example, a collision threat awareness icon may be rendered on the display device 32 indicating which of the features is active.

In some embodiments, the appearance of the collision threat icon 332 can be varied to generate visual alerts and convey other information. For example, the collision threat icon 332 may be altered in appearance to generate a visual alert cautioning the pilot that the helicopter 10 may be, for example, within a minimum distance of the collision threat. This and other visual alerts can be implemented by changing the appearance of the collision threat icon 332 in any number of manners. Other examples may include increasing a size of one or more aspects of the collision threat icon 332, changing a color of one or more aspects of the collision threat icon 332, or any other modification intended to draw the attention of the pilot. In some embodiments, the appearance of the collision threat icon 332 can be changed in other manners to generate alerts and the alerts can increase in urgency depending upon the severity of the alert condition. For example, in the case of a higher level alert, certain aspects can be rendered in a predetermined warning color (e.g., red) or animation (e.g., flashing) can be applied to one or more of aspects of the collision threat icon 332.

The systems and methods disclosed herein provide various benefits over certain existing systems and methods. For example, directing the searchlight 27 to illuminate the collision threat or indicate the escape route may assist the pilot during visual flight of the helicopter 10. Further, rendering the collision threat icon 332 and/or the escape route icon on the display device 32 may assist the pilot during instrument flight of the helicopter 10.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system 100. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first.” “second.” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for providing collision threat awareness for a mobile platform, the system comprising:
a searchlight assembly comprising a searchlight mounted on the mobile platform, the searchlight configured to emit a beam of light and the searchlight assembly configured to controllably articulate the searchlight to modify a direction of the beam of light;
a sensor system configured to sense a location, an elevation, and an orientation of the mobile platform and/or locations and elevations of various obstacles including terrain and manmade objects eternal to the mobile platform;
a source of data including the locations and the elevations of the various obstacles; and
a controller operably coupled to the searchlight assembly, the sensor system, and the source of data, the controller configured to, by a processor:
identify a first obstacle within a flight path of and/or an area adjacent to the mobile platform that poses a collision threat to the mobile platform based on the location, the elevation, and/or the orientation of the mobile platform as sensed by the sensor system and the location and the elevation of the first obstacle as stored in the data and/or sensed by the sensor system;
operate the searchlight assembly to:
automatically direct the beam of light toward the first obstacle; and/or
automatically direct the beam of light toward an escape route determined based on the various obstacles in the data, wherein the escape route represents a safe flight path that allows the mobile platform to avoid collision with the first obstacle.

2. The system of claim 1, wherein the controller is configured to, by the processor, operate the searchlight assembly to direct the beam of light toward the first obstacle.

3. The system of claim 1, wherein the controller is configured to, by the processor, operate the searchlight to direct the beam of light toward the escape route.

4. The system of claim 1, wherein the controller is configured to, by the processor, automatically position lock the searchlight such that the beam of light emitted therefrom is continuously directed toward the first obstacle or toward the escape route while the mobile platform is moving.

5. The system of claim 1, further comprising:
a display device configured to render a terrain environment proximate to the mobile platform,
wherein the controller is configured to, by the processor, render an icon on the display device indicating the first obstacle or the escape route relative to the terrain environment.

6. The system of claim 5, wherein the controller is configured to, by the processor, indicate on the display device when the first obstacle or the escape route is out of a field of view of the terrain environment.

7. The system of claim 6, wherein the controller is configured to, by the processor, render information on the display device that indicates a direction and a distance of the first obstacle or the escape route relative to the mobile platform when the first obstacle or the escape route is out of the field of view of the terrain environment.

8. The system of claim 6, wherein the controller is configured to, by the processor, render the icon as a circle when the first obstacle or the escape route is within the field of view and as a partial circle when the first obstacle or the escape route is out of the field of view.

9. The system of claim 1, wherein the controller is configured to, by the processor, operate the searchlight assembly to automatically fade (i.e., progressively turn off and/or dim) the beam of light upon a determination that the first obstacle is no longer posed a threat of collision to the mobile platform.

10. The system of claim 1, wherein the mobile platform is a helicopter.

11. A method for providing collision threat awareness for a mobile platform, the method comprising:
receiving, with a processor of a controller of the mobile platform, a location, an elevation, and an orientation of the mobile platform from a sensor system of the mobile platform;
receiving, by the processor, data including locations and elevations of various obstacles including terrain and manmade objects from a source of the data and/or the sensor system;
identifying, by the processor, a first obstacle within a flight path of and/or an area adjacent to the mobile platform that poses a collision threat to the mobile platform based on the location, the elevation, and/or the orientation of the mobile platform as sensed by the sensor system and the location and the elevation of the first obstacle as stored in the data;
operating a searchlight assembly to emit a beam of light from a searchlight mounted on the mobile platform;
controllably articulating the searchlight, by the processor, to modify a direction of the beam of light to:
automatically direct the beam of light toward the first obstacle; and/or
automatically direct the beam of light toward an escape route determined based on the various obstacles in the data, wherein the escape route represents a safe flight path that allows the mobile platform to avoid collision with the first obstacle.

12. The method of claim 11, wherein the searchlight is controllably articulated, by the processor, to direct the beam of light toward the first obstacle.

13. The method of claim 11, wherein the searchlight is controllably articulated, by the processor, to direct the beam of light toward the escape route.

14. The method of claim 11, further comprising automatically position locking the searchlight, by the processor, such that the beam of light emitted therefrom is continuously directed toward the first obstacle or toward the escape route while the mobile platform is moving.

15. The method of claim 11, further comprising:
rendering a terrain environment proximate to the mobile platform on a display device of the mobile platform; and
rendering, by the processor, an icon on the display device indicating the first obstacle or the escape route relative to the terrain environment.

16. The method of claim 15, further comprising indicating, by the processor, on the display device when the first obstacle or the escape route is out of a field of view of the terrain environment.

17. The method of claim 16, further comprising rendering, by the processor, information on the display device that indicates a direction and a distance of the first obstacle or the escape route relative to the mobile platform when the first obstacle or the escape route is out of the field of view of the terrain environment.

18. The method of claim 16, further comprising rendering, by the processor, the icon as a circle when the first obstacle or the escape route is within the field of view and as a partial circle when the first obstacle or the escape route is out of the field of view.

19. The method of claim 11, further comprising operating the searchlight assembly, by the processor, to automatically fade the beam of light upon a determination that the first obstacle is no longer poses a threat of collision to the mobile platform.

20. The method of claim 11, wherein the mobile platform is a helicopter.
